(19) United States
(12) Patent Application Publication
(10) Pub. No.: US 2020/0290514 A1
(43) Pub. Date: Sep. 17, 2020

(54) DRIVING ASSISTANCE DEVICE, VEHICLE, AND VEHICLE CONTROL DEVICE

(71) Applicant: HONDA MOTOR CO., LTD., Tokyo (JP)

(72) Inventor: Kenta TAKENAKA, Wako-shi (JP)

(21) Appl. No.: 16/807,497

(22) Filed: Mar. 3, 2020

(30) Foreign Application Priority Data
Mar. 15, 2019 (JP) 2019-048694

(51) Int. Cl. B60R 1/00; B60W 40/04

(52) U.S. Cl. CPC B60R 1/002; B60W 40/04; B60R 2300/8046; B60R 2300/70; B60R 2300/50

(57) ABSTRACT

A driving assistance device includes a first periphery image provision unit and a second periphery image provision units. Each unit provides an image of a periphery of a vehicle to a vehicle occupant. Each unit includes a photographing unit, a display unit, and a control unit configured to control the display unit. The first control unit monitors a state of the second periphery image provision unit and performs processing that notifies information relating to a deterioration in performance of the second periphery image provision unit to a vehicle occupant. The second control unit monitors a state of the first periphery image provision unit and performs processing that notifies information relating to a deterioration in performance of the first periphery image provision unit to a vehicle occupant.

### CROSS-REFERENCE TO RELATED APPLICATION(S)

This application claims priority to and the benefit of Japanese Patent Application No. 2019-048694 filed on Mar. 15, 2019, the entire disclosure of which is incorporated herein by reference.

### BACKGROUND OF THE INVENTION

### Field of the Invention

The present invention relates to a driving assistance device, a vehicle and a vehicle control device.

### Description of the Related Art

A vehicle equipped with a periphery image provision system that includes a camera which photographs the periphery of a vehicle, and a display device that provides the photographed image to a vehicle occupant has been proposed. International Publication No. 2017/203970 discloses a vehicle in which a plurality of such periphery image provision systems are mounted.

In a case where there is a deterioration in the performance of a periphery image provision system, such as when a photographed image is not displayed appropriately on a display device or the like, it is desirable to notify the occurrence of such a situation to a vehicle occupant. However, a case can arise in which the periphery image provision system at which the deterioration in the performance has occurred cannot itself notify the vehicle occupant of the deterioration in the performance.

### SUMMARY OF THE INVENTION

An object of the present invention is, in the case of providing an image of the periphery of a vehicle to an occupant of the vehicle, to more reliably notify the vehicle occupant of a deterioration in the performance of a system.

According to an aspect of the present invention, there is provided a driving assistance device, comprising: a first periphery image provision unit configured to provide an image of a periphery of a vehicle to a vehicle occupant, and a second periphery image provision unit configured to provide an image of a periphery of the vehicle to a vehicle occupant; wherein: the first periphery image provision unit includes: a first photographing unit configured to photograph a periphery of the vehicle, a first display unit configured to display an image photographed by the first photographing unit, and a first control unit configured to control the first display unit; the second periphery image provision unit includes: a second photographing unit configured to photograph a periphery of the vehicle, a second display unit configured to display an image photographed by the second photographing unit, and a second control unit configured to control the second display unit; the first control unit: monitors a state of the second periphery image provision unit; and performs processing that, based on a monitoring result, notifies information relating to a deterioration in performance of the second periphery image provision unit to a vehicle occupant; and the second control unit: monitors a state of the first periphery image provision unit; and performs processing that, based on a monitoring result, notifies information relating to a deterioration in performance of the first periphery image provision unit to a vehicle occupant.

Further features of the present invention will become apparent from the following description of exemplary embodiments (with reference to the attached drawings).

### BRIEF DESCRIPTION OF THE DRAWINGS

FIG. 1A and FIG. 1B are a plan view and a side view of a vehicle according to one embodiment of the present invention.

FIG. 2 is a view illustrating the inside of the cabin of the vehicle illustrated in FIG. 1A and FIG. 1B.

FIG. 3 is a block diagram of a vehicle control device according to one embodiment of the present invention.

FIG. 4 is a flowchart illustrating an example of processing that is executed by the vehicle control device illustrated in FIG. 3.

FIG. 5A is an explanatory diagram of a temperature range.

FIG. 5B is a flowchart illustrating an example of processing that is executed by the vehicle control device illustrated in FIG. 3.

FIG. 6A to FIG. 6C are views illustrating display examples of a display device and an indicator.

FIG. 7 is a flowchart illustrating another example of processing that is executed by the vehicle control device illustrated in FIG. 3.

FIG. 8A and FIG. 8B are flowcharts illustrating a further example of processing that is executed by the vehicle control device illustrated in FIG. 3.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

### First Embodiment

<Configuration of Vehicle>

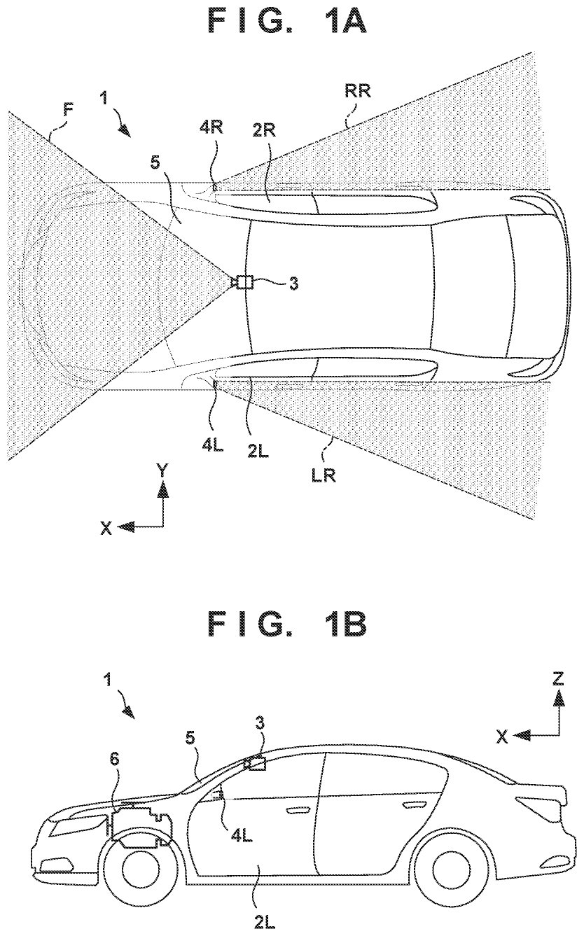

FIG. 1A and FIG. 1B are a plan view and a side view of a vehicle 1 according to one embodiment of the present invention. Note that, in each figure, an arrow X indicates the front-and-rear direction of the vehicle 1, and an arrow Y indicates the vehicle width direction of the vehicle 1. An arrow Z indicates the vertical direction.

As one example, the vehicle 1 is a sedan-type four-wheeled passenger car. The vehicle 1 has two seats in a front row adjacent to a front window 5, and two seats in a rear row, with the seat on the right side of the front row being the driver seat, and the seat on the left side being the front passenger seat. The vehicle 1 has a total of four doors that are adjacent to the respective seats, with a door 2R being a door adjacent to the driver seat that is the right door on the front side. A door 2L is a door adjacent to the front passenger seat, and is the left door on the front side. A drive unit 6 is provided at a front part of the vehicle 1. The drive unit 6 includes a driving source that exerts a propulsive force of the vehicle 1. The driving source is, for example, an engine (internal combustion engine) or a motor, or a combination of the engine (internal combustion engine) and the motor. The drive unit 6 includes a transmission such as an automatic transmission.

The vehicle 1 includes photographing apparatuses 3, 4R and 4L which photograph the periphery of the vehicle 1. Each of the photographing apparatuses 3, 4R and 4L is, for example, a camera that includes an image pickup device such as an image sensor, and an optical system such as a lens. The photographing apparatus 3 photographs an image of a photographing range F at the front of the vehicle 1. An image that was photographed by the photographing apparatus 3 is used, for example, to detect an obstacle in front of the vehicle 1 or to recognize road lane markings (for example, white lines).

The photographing apparatus 4R is disposed at the front of the door 2R, and a photographing range RR thereof is the rearward direction on the right side of the vehicle 1. The photographing apparatus 4L is disposed at the front of the door 2L, and a photographing range LR thereof is the rearward direction on the left side of the vehicle 1.

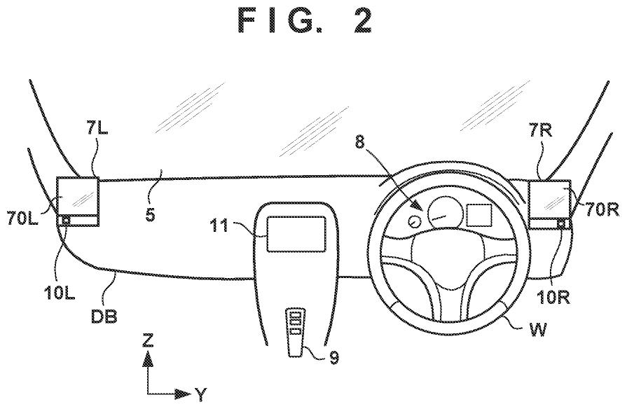

FIG. 2 is a view that schematically illustrates the inside of the cabin of the vehicle 1, and in particular is a view that illustrates the area around a dashboard DB. A steering wheel W is provided in front of the driver seat, and an instrument panel 8 is provided in the dashboard DB on the front side of the steering wheel W. A display device 11 that displays map information and the like is provided at a center part in the vehicle width direction of the dashboard DB, and a shift lever 9 that accepts an operation to shift the transmission is disposed in the vicinity of the display device 11.

A display device 7R is disposed at a right end part of the dashboard DB, and a display device 7L is disposed at a left end part of the dashboard DB. The display devices 7R and 7L are image display devices, and in the case of the present embodiment are liquid crystal display devices. An image that was photographed by the photographing apparatus 4R is displayed on the display device 7R, and an image that was photographed by the photographing apparatus 4L is displayed on the display device 7L.

The vehicle 1 of the present embodiment is a vehicle without side mirrors, and instead of side mirrors (door mirrors), the photographing apparatuses 4R and 4L and the display devices 7R and 7L constitute camera monitoring systems (CMSs) that are provided so as to allow a vehicle occupant (particularly the driver) to check the lateral rearward directions of the vehicle 1. At least while the vehicle 1 is travelling, an image photographed by the photographing apparatus 4R is continuously displayed on the display device 7R, and an image photographed by the photographing apparatus 4L is continuously displayed on the display device 7L.

Indicators 10R and 10L are disposed on the dashboard DB. The indicators 10R and 10L are display devices which notify information relating to a deterioration in the performance of a CMS to a vehicle occupant. In the case of the present embodiment, the indicators 10R and 10L are each constituted by a light emitting device such as an LED, and as the form of notification of information relating to a deterioration in performance, in a case where a performance deterioration occurred or in a case where the possibility of a performance deterioration occurring has increased, the indicators 10R and 10L notify the vehicle occupant to such effect by activating (in this case, lighting up).

Note that, a configuration may be adopted in which the indicators 10R and 10L are only lit in a case where a deterioration in performance occurs. Further, the indicators 10R and 10L may each be an image display device such as a liquid crystal display device. Furthermore, a notification apparatus for notifying information to the vehicle occupant may be an audio output apparatus.

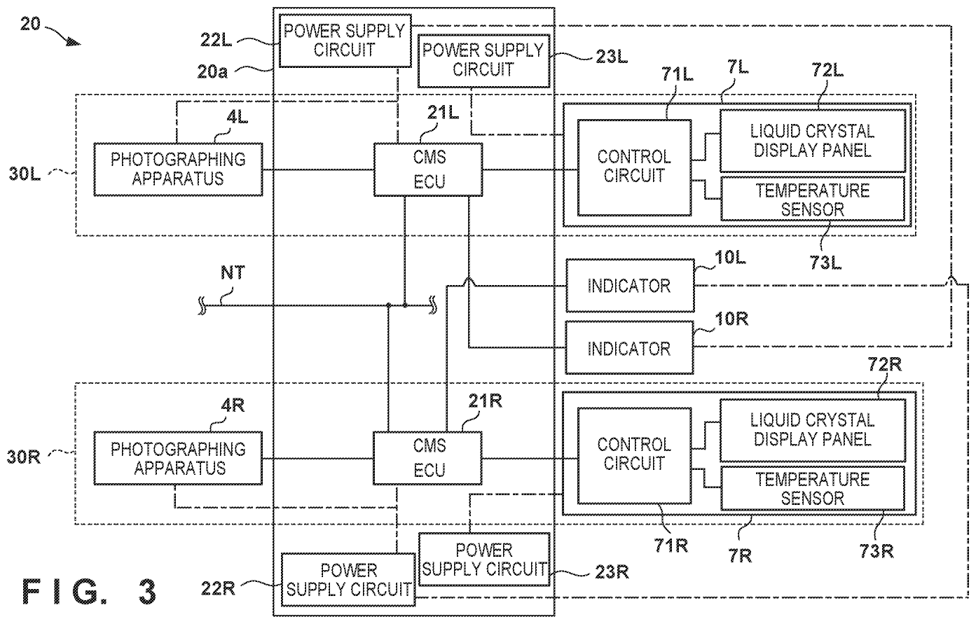

The indicator 10R notifies information relating to a performance deterioration with respect to a CMS (a CMS 30R in FIG. 3) that includes the photographing apparatus 4R and the display device 7R to a vehicle occupant. Therefore, the indicator 10R is arranged adjacent to a display screen 70R of the display device 7R. Although a position at which the indicator 10R may be arranged is not limited to the aforementioned position, according to the arrangement in the present embodiment, it is easy for the vehicle occupant to understand that actuation of the indicator 10R is a notification relating to the CMS 30R.

The indicator 10L notifies information relating to a performance deterioration with respect to a CMS (a CMS 30L in FIG. 3) that includes the photographing apparatus 4L and the display device 7L to a vehicle occupant. Therefore, the indicator 10L is arranged adjacent to a display screen 70L of the display device 7L. Although a position at which the indicator 10L may be arranged is not limited to the aforementioned position, according to the arrangement in the present embodiment, it is easy for the vehicle occupant to understand that actuation of the indicator 10L is a notification relating to the CMS 30L.

FIG. 3 is a block diagram illustrating a vehicle control device 20 which is a driving assistance device that is an on-board apparatus of the vehicle 1, and in particular FIG. 3 illustrates a configuration example relating to the CMSs. The CMS 30L is a system that assists driving by photographing the photographing range LR and providing the photographed image to a vehicle occupant, and includes the photographing apparatus 4L, the display device 7L and an ECU (CMSECU) 21L. The CMS 30R is a system that photographs the photographing range RR and provides the photographed image to a vehicle occupant, and includes the photographing apparatus 4R, the display device 7R and an ECU (CMSECU) 21R.

The ECU 21L is a control unit that performs overall control of the CMS 30L, and in particular performs control of the display device 7L. Further, the ECU 21L performs control of the indicator 10R, and not the indicator 10L. Similarly, the ECU 21R is a control unit that performs overall control of the CMS 30R, and in particular performs control of the display device 7R, and also performs control of the indicator 10L and not the indicator 10R. Thus, with regard to the indicators 10L and 10R, by making the corresponding ECUs the opposite to the CMSs 30L and 30R, even if a performance deterioration occurs in one of the systems, it is possible to notify the performance deterioration to a vehicle occupant.

For example, in a case where a performance deterioration occurs in a part of the configuration of the CMS 30L and a photographed image is no longer displayed, the ECU 21R actuates the indicator 10L so that the occurrence of the performance deterioration in the CMS 30L can be notified to the vehicle occupant. Similarly, in a case where a performance deterioration occurs in a part of the configuration of the CMS 30R and a photographed image is no longer displayed, the ECU 21L actuates the indicator 10R so that the occurrence of the performance deterioration in the CMS 30R can be notified to the vehicle occupant.

The ECUs 21L and 21R each include a processor as typified by a CPU, a storage device such as a semiconductor memory, and an interface with an external device and the like. A program that the processor executes and data that the processor uses for processing and the like are stored in the storage device. Each of the ECUs 21L and 21R may include a plurality of processors, storage devices and interfaces and the like, and the processor may include a CPU and an image processing processor. The image processing processor may have a function that processes the signals of images photographed by the photographing apparatuses 4L and 4R and outputs display image signals to the display devices 7L and 7R. The ECUs 21L and 21R are communicably connected to each other through an in-vehicle network NT.

The display devices 7L and 7R include control circuits 71L and 71R, liquid crystal display panels 72L and 72R, and temperature sensors 73L and 73R, respectively. The control circuits 71L and 71R respectively include a processor as typified by a CPU, a storage device such as a semiconductor memory, an interface with an external device, and a drive circuit for the corresponding liquid crystal display panel 72L or 72R and the like. The control circuit 71L performs driving control of the corresponding liquid crystal display panel 72L and processing that sends a detection result of the temperature sensor 73L to the corresponding ECU 21L and the like. Similarly, the control circuit 71R performs driving control of the corresponding liquid crystal display panel 72R and processing that sends a detection result of the temperature sensor 73R to the corresponding ECU 21R and the like. The temperature sensor 73L detects the temperature of the liquid crystal display panel 72L. Similarly, the temperature sensor 73R detects the temperature of the liquid crystal display panel 72R. The temperature sensors 73L and 73R are, for example, thermistors.

A power supply circuit 22L is connected to an on-board battery, and supplies driving power to the photographing apparatus 4L and the ECU 21L of the CMS 30L and to the indicator 10R. A power supply circuit 23L is connected to an on-board battery, and supplies driving power to the display device 7L of the CMS 30L. A power supply circuit 22R is connected to an on-board battery, and supplies driving power to the photographing apparatus 4R and the ECU 21R of the CMS 30R and to the indicator 10L. A power supply circuit 23R is connected to an on-board battery, and supplies driving power to the display device 7R of the CMS 30R.

By providing separate power supply circuits for the set composed of the CMS 30L and the indicator 10R and for the set composed of the CMS 30R and the indicator 10L, respectively, even if a performance deterioration occurs at one of the power supply circuits, each component that receives a supply of power from the other power supply circuit can be actuated.

For example, in a case where the power supply circuits 22L and 23L can no longer supply the necessary power to each component of the CMS 30L and the indicator 10R, the aforementioned components will no longer operate. However, since the CMS 30R and the indicator 10L are supplied with power from the power supply circuits 22R and 23R, it is possible to actuate the indicator 10L and thereby notify the vehicle occupant of a performance deterioration in the CMS 30L. Similarly, in a case where the power supply circuit 22R can no longer supply the necessary power, it is possible to actuate the indicator 10R and thereby notify the vehicle occupant of a performance deterioration in the CMS 30R.

Further, by providing separate power supply circuits for the display device 7L and for the ECU 21L and indicator 10R, even if a performance deterioration occurs in the power supply circuit 23L, it is possible for the ECU 21L and the indicator 10R to operate by means of power supplied by the power supply circuit 22L. Similarly, by providing separate power supply circuits for the display device 7R and for the ECU 21R and indicator 10L, even if a performance deterioration occurs in the power supply circuit 23R, it is possible for the ECU 21R and the indicator 10L to operate by means of power supplied by the power supply circuit 22R.

In the case of the present embodiment, the power supply circuit 22L, the ECU 21L, the ECU 21R and the power supply circuit 22R are mounted on a control board 20a. By mounting the main components of the control systems of the CMS 30L and CMS 30R on a common control board 20a, assembly of the main components of these control systems in the vehicle 1 as well as maintenance thereof can be simplified.

<Example of Processing of Control Units>

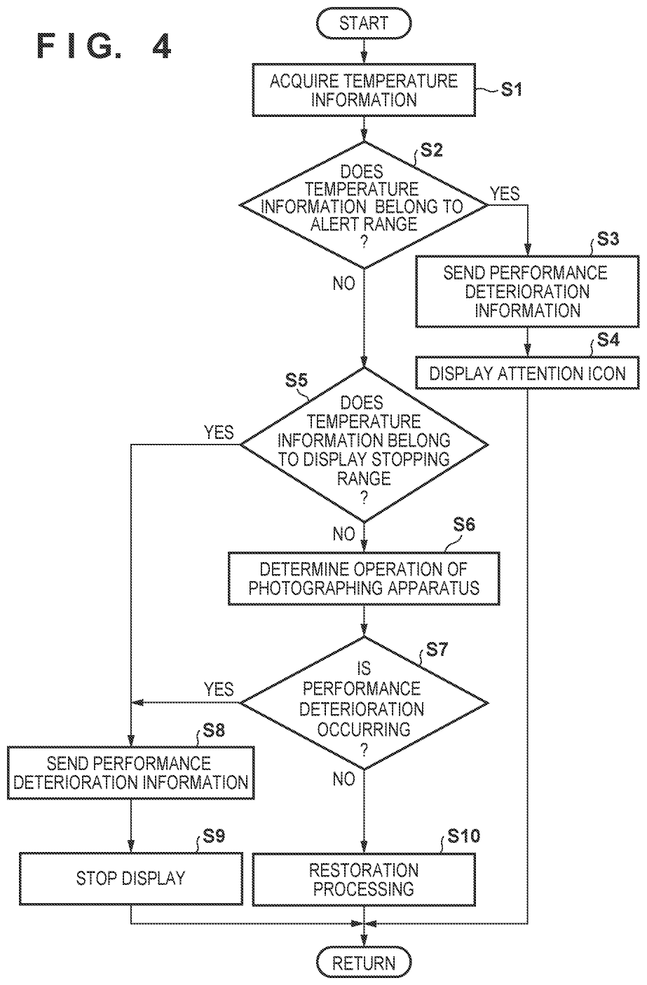

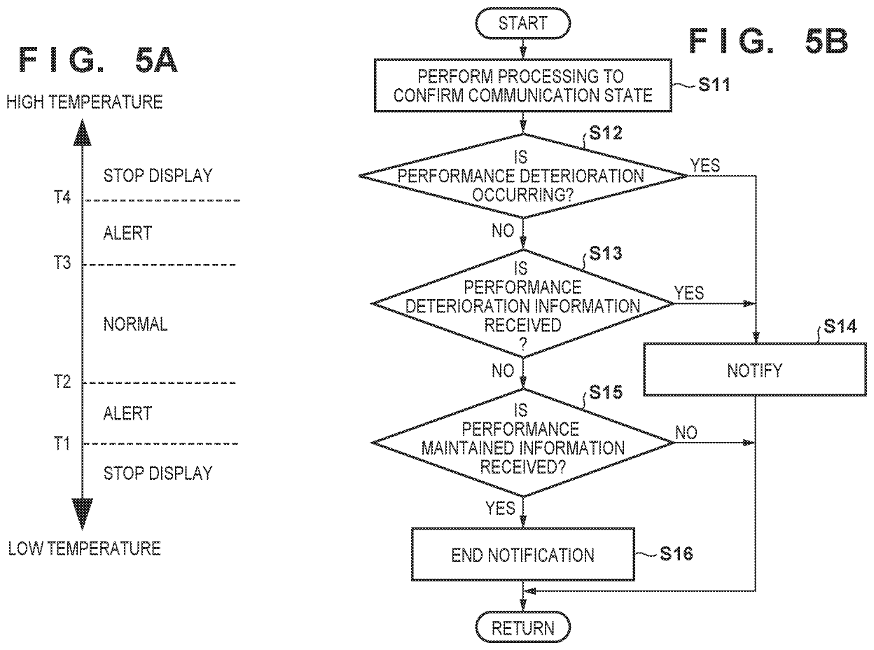

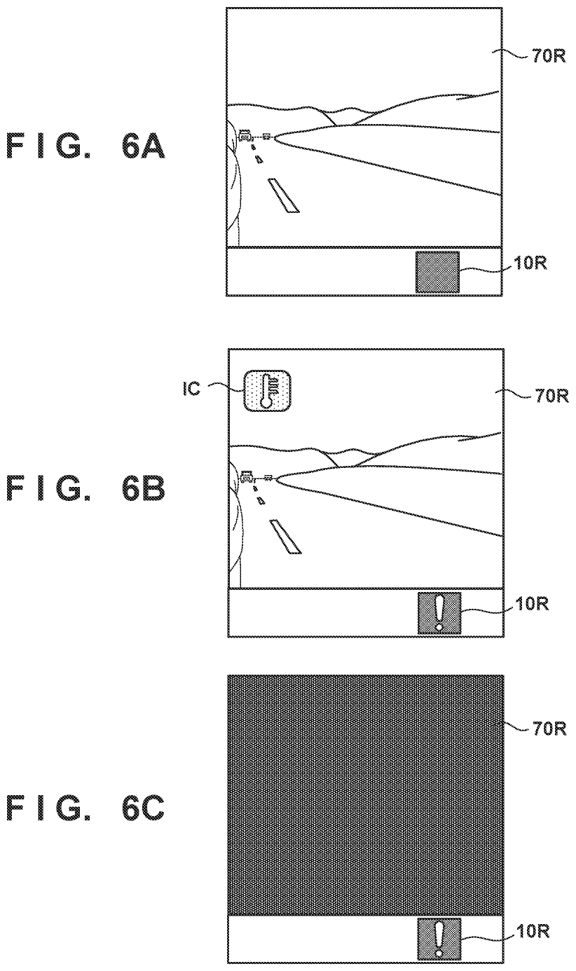

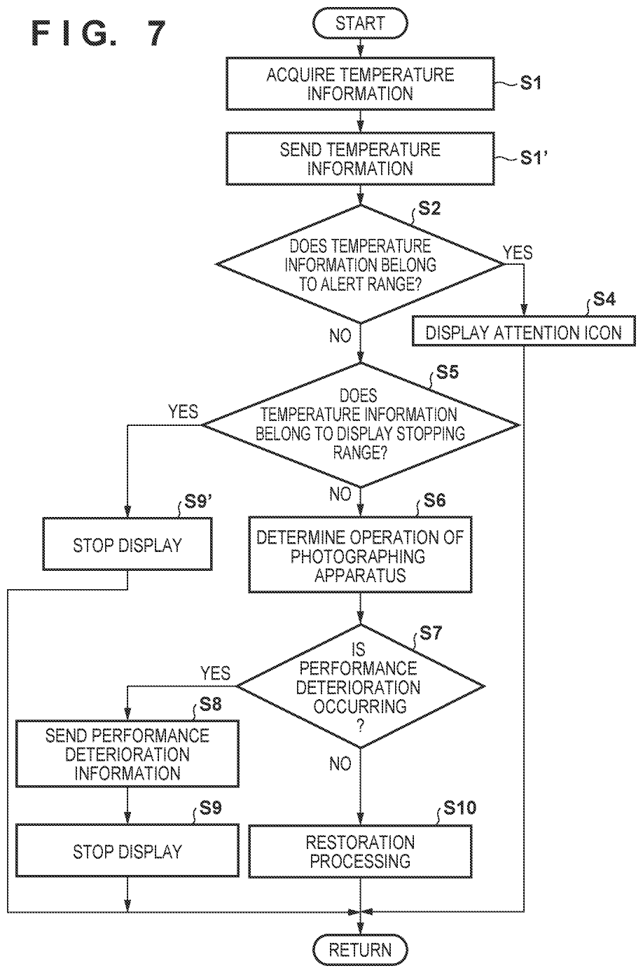

An example of processing which the ECU 21L and the ECU 21R execute will now be described referring to FIG. 4 to FIG. 5B, and FIG. 6A to FIG. 6C. Here, processing for notifying information relating to a performance deterioration in the CMS 30L and the CMS 30R to a vehicle occupant will be described. FIG. 4 and FIG. 5B illustrate processing which the ECU 21L and the ECU 21R repeatedly execute, respectively. FIG. 4 illustrates processing in which the ECU 21L and the ECU 21R determine the state of the CMS to which they belong, i.e. the CMS 30L and the CMS 30R, respectively, and notify information relating to a performance deterioration that is based on the determination result to the vehicle occupant. FIG. 5B illustrates processing in which the ECU 21L and the ECU 21R monitor the state of the CMS to which they do not belong, i.e. the CMS 30R and the CMS 30L, respectively, and notify information relating to a performance deterioration that is based on the monitoring result to the vehicle occupant.

Factors for determining a performance deterioration in the CMS 30L or the CMS 30R in the present embodiment are broadly classified into three kinds, that is, factors for determining a deterioration in the performance of the display devices 7L and 7R, factors for determining a deterioration in the performance of the photographing apparatuses 4L and 4R, and factors for determining a deterioration in the performance of the ECUs 21L and 21R (or a deterioration in the performance of the power supply circuits 22L, 23L, 22R and 23R). However, the number of kinds of factors for determining a performance deterioration may be four or more, or may be only one kind or only two kinds among the aforementioned three kinds.

A deterioration in the performance of the display devices 7L and 7R that is supposed in the present embodiment relates to a deterioration in performance that is caused by the temperature of the liquid crystal display panels 72L and 72R. In general, when a liquid crystal display device is at a high temperature (for example, 80° C. or higher), a decrease in brightness or shortening of the life of the product may occur. Further, at a low temperature (for example, below freezing point), an afterimage may remain in some cases. In some cases, a photographed image may not be displayed clearly due to such temperature factors. The inside of the cabin of the vehicle 1 may become a high temperature during summer, and in cold districts the inside of the cabin may sometimes become a low temperature.

A deterioration in the performance of the photographing apparatuses 4L and 4R is, for example, a case where photographed image sticking occurs (the image pickup signal does not change). The vehicle occupant will experience a sense of incongruity if a photographed image does not change while the vehicle 1 is travelling. A deterioration in the performance of the ECUs 21L and 21R is, for example, a case where execution of a program stops. A deterioration in the performance of the power supply circuit 22L, 23L, 22R or 23R is, for example, a case where required power is not being output.

In the following description, to facilitate understanding, a situation is assumed in which the ECU 21R executes the processing illustrated in FIG. 4, and the ECU 21L executes the processing illustrated in FIG. 5B, although the following description also applies in the opposite case. FIG. 6A to FIG. 6C illustrate display examples of the display screen 70R of the display device 7R and display examples of the indicator 10R. FIG. 6A illustrates a state in which there is no performance deterioration in the CMS 30R, and an image that is photographed by the photographing apparatus 4R is displayed on the display screen 70R. The indicator 10R is in a non-notification state (is not lighting).

In FIG. 4, in S1 the ECU 21R acquires temperature information showing a temperature detection result of the temperature sensor 73R through the control circuit 71R. In S2, the ECU 21R determines whether or not the temperature information acquired in S1 belongs to an alert range. If the ECU 21R determines that the temperature information belongs to the alert range, the ECU 21R proceeds to S3, and if it is determined that the temperature information does not belong to the alert range, the ECU 21R proceeds to S5.

The term “alert range” refers to a temperature range in which the vehicle occupant is to be notified that there is a possibility of the occurrence of a deterioration in the performance of the display devices 7L and 7R. FIG. 5A illustrates examples of ranges relating to a deterioration in the performance of the display devices 7L and 7R, which are classified into a normal range, an alert range, and a display stopping range. The normal range is a temperature range in which it is regarded that there is no performance deterioration caused by the temperature of the display devices 7L and 7R, and is the range from a temperature T2 to a temperature T3. The alert range is a range in which it is possible that a performance deterioration caused by the temperature of the display devices 7L and 7R may occur, and is a range from a temperature T1 to the temperature T2 on the low temperature side, and a range from the temperature T3 to a temperature T4 on the high temperature side. The display stopping range is a temperature range in which it is regarded that a performance deterioration caused by the temperature of the display devices 7L and 7R has occurred or in which the product life will be noticeably shortened, and is a range of temperatures lower than the temperature T1 on the low temperature side, and a range of temperatures higher than the temperature T4 on the high temperature side.

Returning to FIG. 4, in S3 the ECU 21R sends information (performance deterioration information) indicating a performance deterioration in the CMS 30R to the ECU 21L through the in-vehicle network NT. In S4, the ECU 21R displays an attention icon as information indicating a performance deterioration on the display device 7R. FIG. 6B illustrates an example of the display of the display device 7R. An attention icon IC is displayed on the display screen 70R in a manner in which the attention icon IC is superimposed on a photographed image. By using the attention icon IC to notify the vehicle occupant, the vehicle occupant recognizes that there is a possibility that a deterioration in the performance of the display device 7R is occurring.

Returning to FIG. 4, in S5 the ECU 21R determines whether or not the temperature information acquired in S1 belongs to the display stopping range. If the ECU 21R determines that the temperature information belongs to the display stopping range, the ECU 21R proceeds to S8, and if the ECU 21R determines that the temperature information does not belong to the display stopping range, the ECU 21R proceeds to S6. In S6, the ECU 21R makes a determination regarding the operation of the photographing apparatus 4R. In this case, for example, the ECU 21R checks whether or not the photographed image sticking that is described above is occurring. In S7, based on the result of the determination regarding operation of the photographing apparatus 4R in S6, the ECU 21R determines whether a deterioration in the performance of the photographing apparatus 4R is occurring, and if the ECU 21R determines that a performance deterioration is occurring, the ECU 21R proceeds to S8, while if the ECU 21R determines that there is no performance deterioration the ECU 21R proceeds to S10.

In S8, the ECU 21R sends information indicating a performance deterioration in the CMS 30R to the ECU 21L through the in-vehicle network NT. In S9, the ECU 21R stops the display of a photographed image by the display device 7R. FIG. 6C illustrates an example of the display of the display device 7R. In this example, the display screen 70R is blacked out. The vehicle occupant recognizes that a deterioration in the performance of the display device 7R is occurring.

In S10, the ECU 21R performs restoration processing. Here, in a case where the processing in S3 and S4 or in S8 and S9 was performed, the ECU 21R performs processing to restore the display or the like to the original state thereof. Specifically, in order to show that there is not a deterioration in performance at neither the display device 7R nor the photographing apparatus 4R, the ECU 21R sends information (performance maintained information) indicating that the performance of the CMS 30R is being maintained to the ECU 21L through the in-vehicle network NT. Further, the ECU 21R performs an operation to stop the display of the attention icon IC that was displayed in S4, and to release the stopped state of the display of the photographed image that was stopped in S9. Thus, one round of processing ends.

Processing which the ECU 21L performs to monitor the state of the CMS 30R will now be described referring to FIG. 5B. In S11, the ECU 21L performs processing to confirm the communication state. In this case, the ECU 21L performs communication with the ECU 21R through the in-vehicle network NT and verifies whether or not a deterioration in performance is occurring at the ECU 21R. For example, the ECU 21L outputs a response request to the ECU 21R, and in a case where there is no response, the ECU 21L can determine that a deterioration in performance is occurring at the ECU 21R due to a deterioration in the performance of the ECU 21R itself or due to a power interruption at the power supply circuit 22R.

In S12, the ECU 21L determines whether or not a deterioration in performance is occurring at the ECU 21R based on the result of the confirmation processing in S11, and if the ECU 21L determines that a deterioration in performance is occurring, the ECU 21L proceeds to S14, while if the ECU 21L determines that there is no deterioration in performance, the ECU 21L proceeds to S13. In S13, the ECU 21L determines whether or not performance deterioration information was received from the ECU 21R. If performance deterioration information was received, the ECU 21L proceeds to S14, while if performance deterioration information was not received the ECU 21L proceeds to S15.

In S14, the ECU 21L performs processing to notify information relating to a performance deterioration in the CMS 30R to the vehicle occupant. In the present embodiment, the ECU 21L activates the indicator 10R so that the indicator 10R enters a notification state (a lighting state). FIG. 6B and FIG. 6C illustrate an operation example with respect to the indicator 10R. In the example illustrated in FIG. 6B and FIG. 6C, as a result of the indicator 10R lighting, an exclamation mark is displayed. FIG. 6B corresponds to a situation in which, in the processing in S3 and S4 in FIG. 4, the ECU 21R sends performance deterioration information, and the attention icon IC is displayed in a superimposed manner on the photographed image. FIG. 6C corresponds to a situation in which, in the processing in S8 and S9 in FIG. 4, the ECU 21R sends performance deterioration information, and the attention icon IC is displayed in a superimposed manner on the photographed image. Although an example of a display that is caused by a deterioration in the performance of the ECU 21R is not particularly illustrated in the drawings, some kind of image is displayed on the display screen 70R or an image is not displayed thereon, and the indicator 10R enters an operating state. In either case, by the indicator 10R lighting, the fact that a performance deterioration is occurring in the CMS 30R can be more reliably notified to the vehicle occupant.

In S15 in FIG. 5B, the ECU 21L determines whether or not performance maintained information was received from the ECU 21R. If performance maintained information was received, the ECU 21L proceeds to S16. In S16, the ECU 21L performs processing to end notification. Here, in a case where the indicator 10R is operating, the ECU 21L stops operation of the indicator 10R to place the indicator 10R in a non-notification state (not lighting). By this means, for example, in a case where the indicator 10R operated because the temperature of the liquid crystal display panel 72R was a temperature belonging to the alert range and thereafter the temperature returned to the normal range, operation of the indicator 10R is stopped.

As described above, in the present embodiment, by the ECU 21L monitoring the state of the CMS 30R, and the ECU 21R monitoring the state of the CMS 30L, the occurrence of a deterioration in performance in the respective systems of the CMS 30R and the CMS 30L can be more reliably notified to the vehicle occupant. Further, because monitoring of the systems is performed only by means of communication between the ECU 21L and the ECU 21R, the only wiring required for monitoring the systems is the wiring of the in-vehicle network NT, and hence the convenience with respect to wiring is high.

Note that, although in the present embodiment a configuration is adopted in which after the indicators 10L and 10R are operated, it is possible to stop operation of the indicators 10L and 10R by executing S16 in FIG. 5B, a configuration may be adopted in which an operation to restart the drive unit 6 is required to stop operation of the indicators 10L and 10R. The same applies with respect to executing the processing in S10 of FIG. 4 to stop display of the attention icon IC that was displayed in S4 or release the stopped state of the display that was stopped in S9. Alternatively, among the processing to stop display of the attention icon IC displayed in S4 and the processing to release the stopped state of the display that was stopped in S9 by executing S10 of FIG. 4, a configuration may be adopted in which an operation to restart the drive unit 6 is required with respect to releasing the stopped state of the display that was stopped in S9.

Further, although in the present embodiment the temperature sensors 73L and 73R are used for detecting the states of the display devices 7L and 7R, a physical quantity for detecting the states of the display devices 7L and 7R is not limited to a temperature. For example, a performance deterioration may be determined by another physical quantity such as the current or voltage of the liquid crystal display panels 72L and 72R. Further, communication between the ECUs 21L and 21R and the corresponding control circuits 71L and 71R may be used to detect the states of the display devices 7L and 7R. For example, a response request may be sent from the ECU 21L to the control circuit 71L, and if a response is not received the ECU 21L may determine that a deterioration in performance has occurred at the display device 7L.

### Second Embodiment

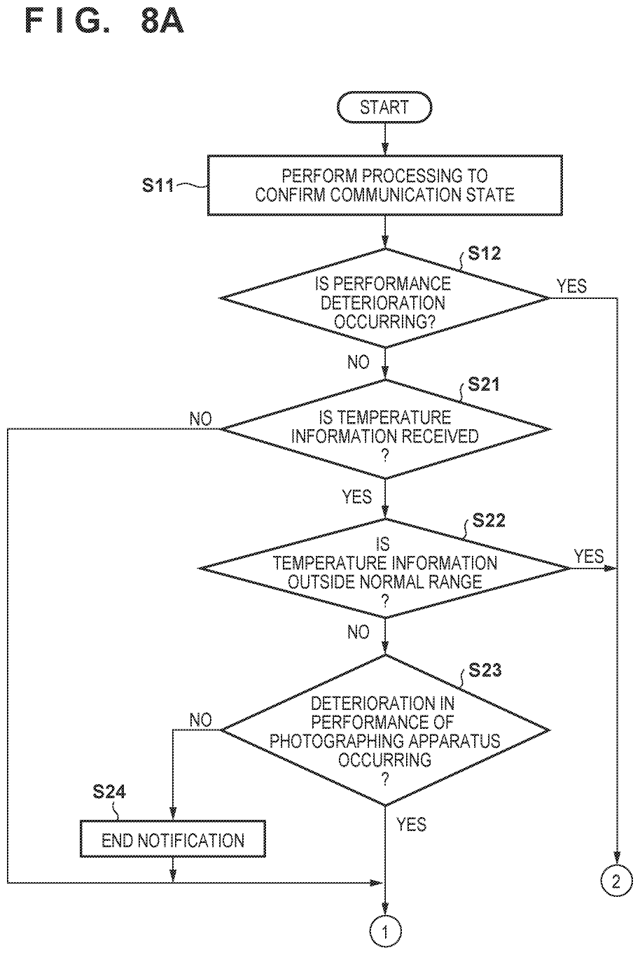

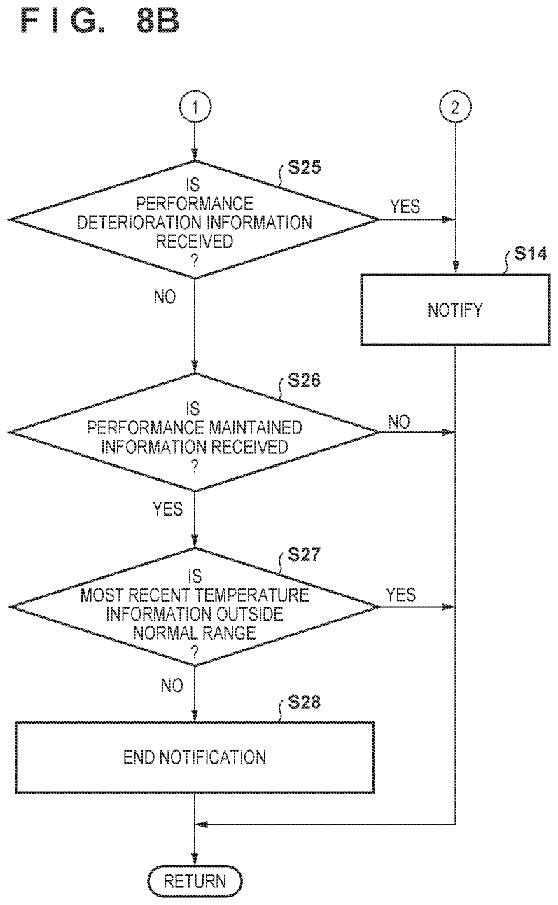

Although in the first embodiment, a configuration is adopted in which processing is performed that, as information based on detection results of the temperature sensors 73L and 73R, sends, from one ECU to the other ECU (S3, S8), performance deterioration information which is information after determining a performance deterioration, a configuration may also be adopted in which processing is performed that sends temperature information from one ECU to the other ECU, and a determination regarding whether to actuate the indicators 10L and 10R is made on the other ECU side. FIG. 7, FIG. 8A and FIG. 8B are flowcharts illustrating processing examples that take the place of the processing examples in FIG. 4 and FIG. 5B. Hereunder, processing that is different from the processing examples in FIG. 4 and FIG. 5B is described, and a description regarding processing that is the same as in the processing examples in FIG. 4 and FIG. 5B is omitted. Further, in the following description, similarly to the first embodiment, to facilitate understanding, a situation is assumed in which the ECU 21R executes the processing illustrated in FIG. 7, and the ECU 21L executes the processing illustrated in FIG. 8A and FIG. 8B, although the following description also applies in the opposite case.

In the processing example illustrated in FIG. 7, in S1′ that is after S1, the ECU 21R sends the temperature information which was acquired in S1 to the ECU 21L through the in-vehicle network NT. The processing in S3 in FIG. 4 is not performed in the present embodiment. In S5, if the ECU 21R determined that the temperature information acquired in S1 belongs to the display stopping range, the ECU 21R proceeds to S9′ and performs display stopping processing that is the same as in S9 in FIG. 4. Thereafter, the ECU 21R ends one unit of processing. Thus, in the present embodiment the ECU 21R does not send performance deterioration information relating to the display device 7R to the ECU 21L.

Monitoring processing performed by the ECU 21L in the present embodiment will now be described referring to FIG. 8A and FIG. 8B. In S12, if the ECU 21L determines that there is no performance deterioration at the ECU 21R, the ECU 21L proceeds to S21. In S21, the ECU 21L determines whether or not temperature information was received from the ECU 21R. If temperature information was received, the ECU 21L proceeds to S22, and if temperature information was not received, the ECU 21L proceeds to S25. In S22, the ECU 21L determines whether or not the received temperature information is outside the normal range (whether or not the received temperature information belongs to the alert range or the display stopping range). If it is determined that the received temperature information is outside the normal range the ECU 21L proceeds to S14, and if it is determined that the received temperature information belongs to the normal range the ECU 21L proceeds to S23.

In S23, based on the performance deterioration information that was already received from the ECU 21R, the ECU 21L determines whether or not a deterioration in the performance of the photographing apparatus 4R is currently occurring, and if the ECU 21L determines that a performance deterioration is occurring the ECU 21L proceeds to S25, while if the ECU 21L determines that a performance deterioration is not occurring, the ECU 21L proceeds to S24. In S24, in a case where the indicator 10R is in a notification state, the ECU 21L ends the operation of the indicator 10R to thereby place the indicator 10R in a non-notification state.

In S25, the ECU 21L determines whether or not performance deterioration information for the photographing apparatus 4R was received from the ECU 21R. If performance deterioration information was received, the ECU 21L proceeds to S14, and if performance deterioration information was not received, the ECU 21L proceeds to S26. In S26, the ECU 21L determines whether or not performance maintained information for the photographing apparatus 4R was received from the ECU 21R. If performance maintained information was received, the ECU 21L proceeds to S27, and if performance maintained information was not received, the ECU 21L ends the processing. In S27, the ECU 21L determines whether or not the most recent temperature information received from the ECU 21R is outside the normal range (whether or not the temperature information belongs to the alert range or display stopping range). If it is determined that the temperature information is outside the normal range, the ECU 21L ends the processing, while if it is determined that the temperature information belongs to the normal range the ECU 21L proceeds to S28. In S28, if the indicator 10R is in a notification state, the ECU 21L ends the operation of the indicator 10R to thereby place the indicator 10R in a non-notification state.

Thus, according to the present embodiment, in the monitoring processing shown in FIG. 8A and FIG. 8B, based on temperature information of the display device 7R of the CMS 30R that is the monitoring object, the ECU 21L can determine that there is a deterioration in the performance of the display device 7R, and can actuate the indicator 10R.

### Other Embodiments

Although in the embodiments described above, the vehicle 1 is a vehicle without side mirrors, the present invention is also applicable to a vehicle with side mirrors. Further, although the ECUs 21L and 21R of the CMS 30L and CMS 30R that provide images of the lateral rearward directions of the vehicle 1 are configured so as to monitor each other's systems, the present invention is not limited thereto. For example, a configuration may be adopted in which the respective ECUs of a system that provides an image of the front of the vehicle 1 and a system that provides an image of the rear of the vehicle 1 monitor each other's systems. Further, the respective ECUs of three or more systems may monitor each other's systems.

### Summary of Embodiments

The above embodiments disclose at least the following driving assistance device, vehicle and vehicle control device.

1. A driving assistance device (for example, 20) of the aforementioned embodiments is a driving assistance device that includes:

a first periphery image provision unit (for example, 30L) configured to provide an image of a periphery of a vehicle to a vehicle occupant, and

a second periphery image provision unit (for example, 30R) configured to provide an image of a periphery of the vehicle to a vehicle occupant;

wherein:

the first periphery image provision unit includes:

a first photographing unit (for example, 4L) configured to photograph a periphery of the vehicle,

a first display unit (for example, 7L) configured to display an image photographed by the first photographing unit, and

a first control unit (for example, 21L) configured to control the first display unit;

the second periphery image provision unit includes:

a second photographing unit (for example, 4R) configured to photograph a periphery of the vehicle,

a second display unit (for example, 7R) configured to display an image photographed by the second photographing unit, and

a second control unit (for example, 21R) configured to control the second display unit;

the first control unit:

monitors a state of the second periphery image provision unit, and performs processing that, based on a monitoring result, notifies information relating to a deterioration in performance of the second periphery image provision unit to a vehicle occupant (for example, S14); and

the second control unit:

monitors a state of the first periphery image provision unit, and performs processing that, based on a monitoring result, notifies information relating to a deterioration in performance of the first periphery image provision unit to a vehicle occupant (for example, S14).

According to this embodiment, when providing images of the periphery of a vehicle to a vehicle occupant, a deterioration in the performance of a system can be more reliably notified to a vehicle occupant.

2. In the aforementioned embodiment:

the first control unit monitors a state of the second periphery image provision unit by means of communication with the second control unit (for example, FIG. 5B, FIG. 8A and FIG. 8B), and

the second control unit monitors a state of the first periphery image provision unit by means of communication with the first control unit (for example, FIG. 5B, FIG. 8A and FIG. 8B).

According to this embodiment, it is possible for each of the control units to monitor each other's system by means of only communication between each of the control units, and thus convenience with respect to wiring and the like can be achieved.

3. In the aforementioned embodiment:

the first periphery image provision unit includes a first detection unit (for example, 73L) configured to detect a state of the first display unit;

the second periphery image provision unit includes a second detection unit (for example, 73R) configured to detect a state of the second display unit;

the first control unit sends information that is based on a detection result of the first detection unit (for example, performance deterioration information or temperature information) to the second control unit, and the second control unit monitors a state of the first display unit by means of the information that is received (for example, FIG. 5B, FIG. 8A and FIG. 8B), and

the second control unit sends information that is based on a detection result of the second detection unit (for example, performance deterioration information or temperature information) to the first control unit, and the first control unit monitors a state of the second display unit by means of the information that is received (for example, FIG. 5B, FIG. 8A and FIG. 8B).

According to this embodiment, it is possible for each of the control units to monitor each other's display unit by means of only communication between each of the control units, and thus convenience with respect to wiring and the like can be achieved.

4. The aforementioned embodiment further includes:

a first notification unit, and

a second notification unit, wherein:

the first control unit (for example, 21L) notifies information relating to a deterioration in performance of the second periphery image provision unit (for example, 30R) to a vehicle occupant by means of the first notification unit (for example, 10R), and

the second control unit (for example, 21R) notifies information relating to a deterioration in performance of the first periphery image provision unit (for example, 30L) to a vehicle occupant by means of the second notification unit (for example, 10L).

According to this embodiment, even in a case where there is a deterioration in the performance of the respective display units, a deterioration in the performance of the system can be notified to a vehicle occupant by the respective notification units.

5. In the aforementioned embodiment:

the first notification unit is a first indicator (for example, 10R) that is disposed adjacent to a display screen (for example, 70R) of the second display unit (for example, 7R), and

the second notification unit is a second indicator (for example, 10L) that is disposed adjacent to a display screen (for example, 70L) of the first display unit (for example, 7L).

According to this embodiment, a system in which a performance deterioration is occurring can be notified to a vehicle occupant in a more easily understandable manner.

6. In the aforementioned embodiment:

the first control unit monitors a state of the first display unit, and displays information (for example, IC) relating to a deterioration in performance of the first display unit on the first display unit based on a monitoring result;

the second control unit actuates the second indicator based on a monitoring result regarding a state of the first display unit;

the second control unit monitors a state of the second display unit, and displays information (for example, IC) relating to a deterioration in performance of the second display unit on the second display unit based on a monitoring result; and

the first control unit actuates the first indicator based on a monitoring result regarding a state of the second display unit.

According to this embodiment, because the respective display units and the respective indicators are controlled by different control units, even if a deterioration in performance occurs in either of the systems, it is possible to notify the deterioration in performance to the vehicle occupant.

7. The aforementioned embodiment further includes:

a first power supply circuit (for example, 22L) configured to supply electric power to the first photographing unit, the first control unit and the first notification unit; and

a second power supply circuit (for example, 22R) configured to supply electric power to the second photographing unit, the second control unit and the second notification unit.

According to this embodiment, even if a power interruption occurs in one of the systems, electric power can be supplied to the other system, and thus notification of a deterioration in the performance of a system is possible.

8. In the aforementioned embodiment:

the first display unit and the second display unit are each a liquid crystal display device; and

the first detection unit and the second detection unit are each a temperature sensor.

According to this embodiment, a deterioration in the performance of the respective display units that is caused by the temperature can be notified.

9. In the aforementioned embodiment:

the vehicle is a vehicle without side mirrors;

the first photographing unit photographs a rearward direction on a left side (for example, LR) of the vehicle;

the first display unit is disposed on a left side of the vehicle;

the second photographing unit photographs a rearward direction on a right side (for example, RR) of the vehicle; and

the second display unit is disposed on a right side of the vehicle.

According to this embodiment, in a vehicle without side mirrors, a deterioration in the performance of a system can be more reliably notified to a vehicle occupant.

10. A vehicle (for example, 1) of the aforementioned embodiment includes:

the aforementioned driving assistance device (for example, 20).

According to this embodiment, when providing images of the periphery of a vehicle to a vehicle occupant, a deterioration in the performance of a system can be more reliably notified to the vehicle occupant.

11. The vehicle control device (for example, 20) of the aforementioned embodiment includes:

a first control unit (for example, 21L) configured to control a first display unit (for example, 4L) configured to display an image of a periphery of a vehicle; and

a second control unit (for example, 21R) configured to control a second display unit (for example, 4R) configured to display an image of a periphery of the vehicle; wherein:

the first control unit:

monitors a state of the second display unit, and performs processing (for example, S14) to notify information relating to a deterioration in performance of the second display unit to a vehicle occupant based on a monitoring result; and

the second control unit:

monitors a state of the first display unit and performs processing (for example, S14) to notify information relating to a deterioration in performance of the first display unit to a vehicle occupant based on a monitoring result.

According to this embodiment, when providing images of the periphery of a vehicle to a vehicle occupant, a deterioration in the performance of a system can be more reliably notified to the vehicle occupant.

The invention is not limited to the foregoing embodiments, and various variations/changes are possible within the spirit of the invention.

What is claimed is:

1. A driving assistance device, comprising:
a first periphery image provision unit configured to provide an image of a periphery of a vehicle to a vehicle occupant, and
a second periphery image provision unit configured to provide an image of a periphery of the vehicle to a vehicle occupant;
wherein:
the first periphery image provision unit includes:
a first photographing unit configured to photograph a periphery of the vehicle,
a first display unit configured to display an image photographed by the first photographing unit, and
a first control unit configured to control the first display unit;
the second periphery image provision unit includes:
a second photographing unit configured to photograph a periphery of the vehicle,
a second display unit configured to display an image photographed by the second photographing unit, and
a second control unit configured to control the second display unit;
the first control unit:
monitors a state of the second periphery image provision unit; and
performs processing that, based on a monitoring result, notifies information relating to a deterioration in performance of the second periphery image provision unit to a vehicle occupant; and
the second control unit:
monitors a state of the first periphery image provision unit; and
performs processing that, based on a monitoring result, notifies information relating to a deterioration in performance of the first periphery image provision unit to a vehicle occupant.

2. The driving assistance device according to claim 1, wherein:
the first control unit monitors a state of the second periphery image provision unit by means of communication with the second control unit; and
the second control unit monitors a state of the first periphery image provision unit by means of communication with the first control unit.

3. The driving assistance device according to claim 1, wherein:
the first periphery image provision unit comprises a first detection unit configured to detect a state of the first display unit;
the second periphery image provision unit comprises a second detection unit configured to detect a state of the second display unit;
the first control unit sends information that is based on a detection result of the first detection unit to the second control unit, and the second control unit monitors a state of the first display unit by means of the information that is received; and
the second control unit sends information that is based on a detection result of the second detection unit to the first control unit, and the first control unit monitors a state of the second display unit by means of the information that is received.

4. The driving assistance device according to claim 1, further comprising:
a first notification unit; and
a second notification unit, wherein:
the first control unit notifies information relating to a deterioration in performance of the second periphery image provision unit to a vehicle occupant by means of the first notification unit; and
the second control unit notifies information relating to a deterioration in performance of the first periphery image provision unit to a vehicle occupant by means of the second notification unit.

5. The driving assistance device according to claim 4, wherein:
the first notification unit is a first indicator that is disposed adjacent to a display screen of the second display unit; and
the second notification unit is a second indicator that is disposed adjacent to a display screen of the first display unit.

6. The driving assistance device according to claim 5, wherein:
the first control unit monitors a state of the first display unit, and displays information relating to a deterioration in performance of the first display unit on the first display unit based on a monitoring result;
the second control unit actuates the second indicator based on a monitoring result regarding the state of the first display unit;
the second control unit monitors a state of the second display unit, and displays information relating to a deterioration in performance of the second display unit on the second display unit based on a monitoring result; and
the first control unit actuates the first indicator based on a monitoring result regarding the state of the second display unit.

7. The driving assistance device according to claim 4, comprising:
a first power supply circuit configured to supply electric power to the first photographing unit, the first control unit and the first notification unit; and
a second power supply circuit configured to supply electric power to the second photographing unit, the second control unit and the second notification unit.

8. The driving assistance device according to claim 3, wherein:
the first display unit and the second display unit are each a liquid crystal display device; and
the first detection unit and the second detection unit are each a temperature sensor.

9. The driving assistance device according to claim 1, wherein:
the vehicle is a vehicle without side mirrors;
the first photographing unit photographs a rearward direction on a left side of the vehicle;
the first display unit is disposed on a left side of the vehicle;
the second photographing unit photographs a rearward direction on a right side of the vehicle; and
the second display unit is disposed on a right side of the vehicle.

10. A vehicle comprising a driving assistance device according to claim 1.

11. A vehicle control device, comprising:
a first control unit configured to control a first display unit configured to display an image of a periphery of a vehicle; and
a second control unit configured to control a second display unit configured to display an image of a periphery of the vehicle; wherein:
the first control unit:
monitors a state of the second display unit; and
performs processing to notify information relating to a deterioration in performance of the second display unit to a vehicle occupant based on a monitoring result; and
the second control unit:
monitors a state of the first display unit; and
performs processing to notify information relating to a deterioration in performance of the first display unit to a vehicle occupant based on a monitoring result.
